(19) United States
(12) Patent Application Publication
(10) Pub. No.: US 2026/0046758 A1
(43) Pub. Date: Feb. 12, 2026

(54) ENHANCEMENTS FOR CONTROLLING RADIO ACCESS TECHNOLOGY UTILIZATION

(71) Applicant: Apple Inc., Cupertino, CA (US)

(72) Inventors: Vivek G. Gupta, San Jose, CA (US); Basant Kumar, Bangalore (IN); Shashanka Totadamane Ramappa, Shivamogga (IN); Haijing Hu, Los Gatos, CA (US); Anikethan Ramakrishna Vijaya Kumar, Mysuru (IN); Stanley M. Mayalil, San Jose, CA (US); Sridhar Prakasam, Fremont, CA (US); Nirlesh Koshta, Bangalore (IN)

(73) Assignee: Apple Inc., Cupertino, CA (US)

(21) Appl. No.: 19/293,543

(22) Filed: Aug. 7, 2025

(30) Foreign Application Priority Data
Aug. 9, 2024 (IN) 202411060323

(51) Int. Cl. H04W 48/18; H04W 48/16; H04W 60/04; H04W 84/04

(52) U.S. Cl. CPC H04W 48/18; H04W 48/16; H04W 60/04; H04W 84/042

(57) ABSTRACT

Techniques are provided for restricted radio access technology-based cell selection. An example method can include processing information from a public land mobile network (PLMN) indicating a first restricted radio access technology (RAT). The method can further include accessing memory to identify a set of RATs for connecting with the PLMN. The method can further include selecting a second RAT instead of the first restricted RAT from the set of RATs-based on the indication of the first restricted RAT. The method can further include connecting with a cell of the PLMN using the second RAT.

### CROSS-REFERENCES TO RELATED APPLICATIONS

This application claims priority to Indian Patent Application number 202411060323, filed on Aug. 9, 2024, which is incorporated by reference in its entirety for all purposes.

### BACKGROUND

Cellular communications can be defined in various standards to enable communications between a user equipment and a cellular network. For example, a long-term evolution (LTE) network and Fifth generation mobile network (5G) are wireless standards that aim to improve upon data transmission speed, reliability, availability, and more.

### BRIEF DESCRIPTION OF THE DRAWINGS

FIG. 1 is an illustration of an example communication environment, according to one or more embodiments.

FIG. 2 is an example signaling diagram for providing radio access technology (RAT) information, according to one or more embodiments.

FIG. 3 is an example signaling diagram for providing RAT information, according to one or more embodiments.

FIG. 4 is an example signaling diagram for providing RAT information, according to one or more embodiments.

FIG. 5 is an example signaling diagram for providing RAT information, according to one or more embodiments.

FIG. 6 is an example signaling diagram for providing RAT information, according to one or more embodiments.

FIG. 7 is an illustration of an example UE network capability information element (IE) according to one or more embodiments.

FIG. 8 is an illustration of an example restricted RAT IE, according to one or more embodiments.

FIG. 9 is an illustration of an example PLMN identifier, according to one or more embodiments.

FIG. 10 is an illustration of an example restricted RAT IE, according to one or more embodiments.

FIG. 11 is an illustration of an ATTACH ACCEPT message, according to one or more embodiments.

FIG. 12 is an illustration of a TRACKING AREA UPDATE ACCEPT message, according to one or more embodiments.

FIG. 13 is an illustration of a REGISTRATION ACCEPT message, according to one or more embodiments.

FIG. 14 is an illustration of a REGISTRATION REJECT message, according to one or more embodiments.

FIG. 15 is an illustration of a CONFIGURATION UPDATE COMMAND message, according to one or more embodiments.

FIG. 16 is an illustration of a SERVICE ACCEPT message, according to one or more embodiments.

FIG. 17 is an example process for providing RAT information, according to one or more embodiments.

FIG. 18 illustrates an example of receive components, in accordance with some embodiments.

FIG. 19 illustrates an example of a UE, in accordance with some embodiments.

FIG. 20 illustrates an example of a network node, in accordance with some embodiments.

### DETAILED DESCRIPTION

A radio access technology (RAT) can include the underlying techniques for enabling a user equipment (UE) to connect with a network to receive services. The RAT is the physical medium (air interface) used to communicate with the network. Examples of RATs can include 2G (GSM), 3G (UMTS), 4G (long term evolution LTE), 5G (5G NR), and 6G. A UE can be configured to connect to a network using various RATs. A public land mobile network (PLMN) can be configured to restrict access to certain RATs for some users. For example, a PLMN can restrict the use of 5G RATs for particular users in certain areas.

The embodiments herein describe techniques for a network to indicate to a UE as to which RATs may be restricted for a UE. This information can be provided as a list of restricted RATs. The UE can use the list of restricted RATs to select an available RAT to connect with a network. The list of restricted RATs can be provided to the UE through various manners. For example, the list of restricted RATs can be provided during a registration procedure, a service request procedure, or other appropriate manner. In some instances, the UE's subscriber identity module (SIM) card can be configured with the list of restricted RATs. As described below, the techniques herein can reduce the time a UE spends connecting with a network. For example, if the UE is rejected from connecting with the network for using a restricted RAT, the UE can spend time selecting another RAT and reattempting to connect with the network. Furthermore, using the restricted RAT consumes time and resources that could have been avoided if the UE selected an available RAT to use in the first attempt to connect with the network. The techniques described herein enable the UE to select an available RAT before attempting a network connection. Therefore, the UE does not waste time and resources attempting to connect to the network using a restricted RAT.

In release (Rel)-19 of 3GPP, core network and terminals (CT) 1 WG has agreed on a new work item on enhancement of controlling radio access technology (RAT) utilization (ECRATU) in CP-241298. UEs rely on national roaming services for seamless connectivity when moving about, especially when moving in areas where the primary network operator lacks coverage. However, allowing the UEs unrestricted use of radio access technologies (RAT) for national roamers can result in technical challenges for networks, such as interoperability issues, quality of service (QoS) concerns, and network congestion concerns. The current mechanism to limit the UEs utilization of certain RATs employed by the network operators involves rejecting the UE's attach/tracking area update (TAU) request or the registration request messages. For example, the network can respond with cause code #15 (no suitable cells in tracking area) or cause code #27 (N1 mode not allowed) in response to a UEs attempt to attach/register with the network via a specific RAT. However, this mechanism results in higher signaling loads within the network, service outage until the UE selects another RAT, and the UE keeps re-attempting to attach/register on the same PLMN/RAT upon the UE re-enabling the corresponding RAT.

CTI has agreed to study mitigating the above drawbacks through enhancements to the delivery of RAT utilization restriction information to the UE in an evolved packet system (EPS) and 5GS, and the corresponding UE behavior, specifying the criterion for re-enabling a previously disabled RAT, and specify the Access Restriction Data update in the HSS/UDM to enable limitation of RAT utilization performed at the MME/AMF.

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc., in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “user equipment” or “UE” as used herein refers to a device with radio communication capabilities and may describe a remote user of network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface.

The term “base station” as used herein refers to a device with radio communication capabilities, that is a network component of a communications network (or, more briefly, a network), and that may be configured as an access node in the communications network. A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, etc.

The term “network” as used herein reference to a communications network that includes a set of network nodes configured to provide communications functions to a plurality of user equipment via one or more base stations. For instance, the network can be a public land mobile network (PLMN) that implements one or more communication technologies including, for instance, 5G communications.

The term “information element” refers to a structural element containing one or more fields. The term “field” refers to individual contents of an information element, or a data element that contains content. An information element may include one or more additional information elements.

The term “3GPP Access” refers to accesses (e.g., radio access technologies) that are specified by 3GPP standards. These accesses include, but are not limited to, GSM/GPRS, LTE, LTE-A, 5G NR, or 6G. In general, 3GPP access refers to various types of cellular access technologies.

The term “Non-3GPP Access” refers to any accesses (e.g., radio access technologies) that are not specified by 3GPP standards. These accesses include, but are not limited to, WiMAX, CDMA2000, Wi-Fi, WLAN, or fixed networks. Non-3GPP accesses may be split into two categories, “trusted” and “untrusted.” Trusted non-3GPP accesses can interact directly with an evolved packet core (EPC) or a 5G core (5GC), whereas untrusted non-3GPP accesses interwork with the EPC/5GC via a network entity, such as an Evolved Packet Data Gateway or a 5G NR gateway. In general, non-3GPP access refers to various types on non-cellular access technologies.

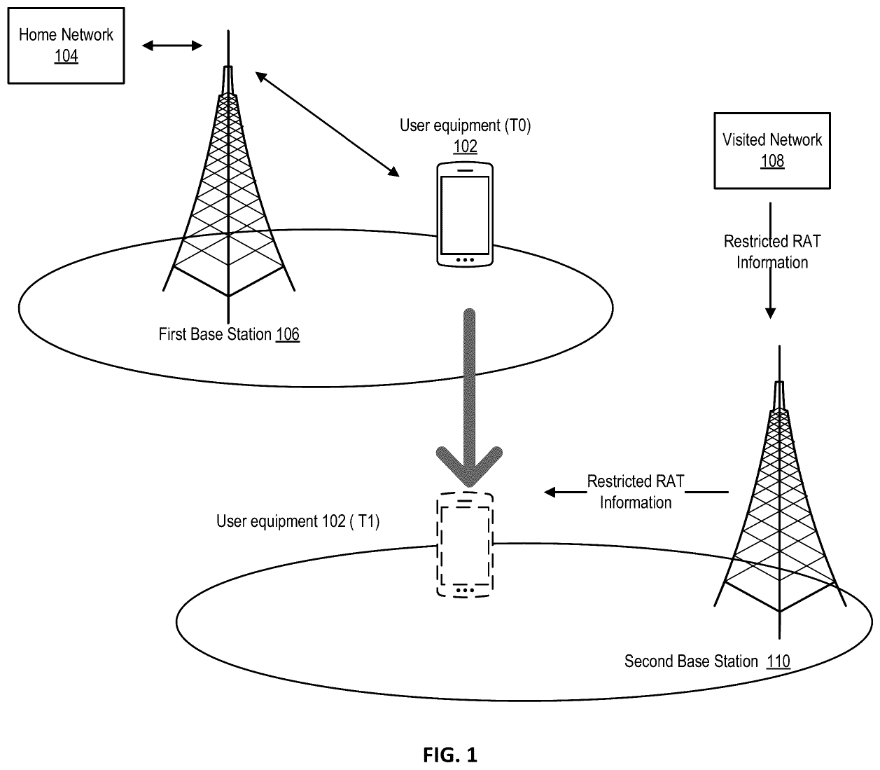

FIG. 1 is an illustration of an example communication environment, according to one or more embodiments. Network operators can enter into roaming agreements with one another. A roaming agreement can enable a user equipment (UE) to connect with a visited network and receive services outside of its home network. For example, a UE 102 may move outside of the coverage area of the home network 104 and reconnect with a visited network 108 to continue receiving services. As illustrated, a UE 102 at T₀ can be connected to a home network 104 via first base station 106. Furthermore, the home network 104 can be operated by a first public land mobile network (PLMN). Then at T₁ the UE 102 can move outside the coverage area of the home network 104 and into the coverage area of the visited network 108. The visited network 108 can be operated by a second PLMN.

The services that the home network 104 can provide to the UE 102 can be different than the services that the visited network 108 can provide to the UE 102. The first PLMN and the second PLMN can configure their services based on a roaming agreement. For example, the visited network 108 can restrict certain radio access technologies (RATs) that UE 102 can use to receive services while connected to the home network 104.

As an example, the first PLMN and the second PLMN can operate within the same country and configure their networks to only utilize 2G and 4G RATs for the UE 102 while within a country. The UE 102 may be forbidden to use a 5G RAT while connected to the visited network 108. Alternatively, the visited network 108 can be configured to permit the UE 102 to use a 5G RAT within specific geographical areas. For example, the visited network 108 can allow the UE 102 to use 5G within a geographic area defined by a tracking area identity (TAI) list.

The UE 102 at T₁ can communicate with the second base station 110 to attempt to connect or re-connect with the visited network 108. As described above, a conventional UE 102 may attempt to connect with the visited network 108 using a restricted RAT. For example, the UE 102 may be restricted from connecting to the visited network 108 using a 5G RAT. The visited network 108, in response to receiving the connection request via the restricted RAT, can send a reject cause code #15 (no suitable cells in tracking area) or a reject cause code #27 (N1 mode not allowed). For example, when the UE 102 either attempts to connect to the visited network 108, conventionally the visited network 108 can transmit a reject cause code (e.g., #15 or #27) in a REGISTRATION REJECT message to prevent the UE 102 from registering with the network using the restricted RAT. However, due to the higher number of subscribers for national inbound roaming compared to the number of subscribers for international inbound roaming, the approach of relying on sending reject cause codes can lead to higher signaling loads into the restricted RAT. Furthermore, the REGISTRATION REJECT message can be sent without integrity protection and can be susceptible to misuse.

Consider an example in which the restricted RAT is 5G NR. In the event that the UE 102 attempts to connect with the visited network 108 using 5G NR, service interruption can occur, the service interruption can extend from 22 seconds to more, with a potential delay of up to twelve minutes to restore service on a 4G network. After returning to 4G, the UE 102 can send a TRACKING AREA UPDATE (TAU) message, which can result in a TAU REJECT message with cause code #9. As a result, the UE 102 can be required to undergo a reattachment procedure to reconnect with the visited network 108. It should be appreciated that PLMN-RAT deployment and the applicability of roaming agreements is not known to the UE 102 which results in unnecessary scans to gain service resulting in delay in service and battery drain. Furthermore, current methods of indicating this with rejection cause codes, such as cause code #15 still does not avoid the UE performing cell searches on all RATs.

The above described scenarios can result in various issues, such as how does the UE 102 resolve interoperability issues, quality of service (QoS) concerns and network congestion concerns during national roaming and during loss of coverage. Another issue can be how does the UE 102 discover what roaming agreements with PLMNs are across which RATs. Another issue can be how does the UE 102 discover the above in different areas across, for example, a 4G evolved packet system (EPS) network or 5G network. Another issue is what information is provisioned in the UE 102 for appropriate RAT utilization during roaming. Another issue is what criterion is used for disabling use of at RAT and later enabling use of the RAT. Another issue is how does a network communicate to the UE 102 that a particular RAT is unavailable and later that the RAT is available for usage.

The embodiments described herein address these issues by providing techniques for the network (e.g., home network 104 or visited network 108) to provide a list of restricted RATs using non-access stratum (NAS) messages and a new information element (IE) (e.g., a restricted RAT IE). It should be appreciated that in some embodiments, the network can include an evolved packet system (EPS) that includes evolved packet core (EPC) that includes a mobility management entity (MME) that can manage mobility, authentication, and session management. The EPS can be the 4G LTE network or part of a 5G non-standalone (NSA) network. In some embodiments, the network can be a 5G network that includes an access and mobility management function (AMF), which can be a control plane function for registration management, connection management, reachability management, and mobility management.

The MME or the AMF can cause the network to transmit a list of restricted RATs associated with the current registered PLMN to the UE 102 via either the EPS or 5G NR, depending on the network. The list of restricted RATs can be transmitted to the UE 102 via a restricted RAT IE. If any RAT associated with the current registered PLMN is restricted, and if the applicability information within the restricted RAT IE specifies that “Restriction on the utilization of RAT applies within the current registered PLMN”, then the UE 102 can disable a RAT and PLMN combination stored in memory and refrain from utilizing the restricted RAT for cell selection and cell re-selection until a different PLMN is selected. For example, the restricted RATs may be applicable for the visited network 108. However, once the UE 102 leaves the coverage area of the visited network 108 and returns to the coverage area of the home network 104, the UE 102 can perform a cell selection or cell re-selection using the RATs that were previously restricted by the visited network 108.

Additionally, if the applicability information within the restricted RAT IE specifies that “Restriction on the utilization of RAT applies to any tracking area of the TAI list within the current registered PLMN”, the UE 102 can refrain from utilizing the restricted RAT for cell selection and cell re-selection until the current TAI is not part of the restricted TAI list. Each tracking area (TA) can be an area within the network. Therefore, the network may restrict certain RATs in some TAs and not in other TAs.

The network can provide the UE 102 with the restricted RAT information. For example, for a 4G LTE network, when the UE 102 enters a location within the network, the UE 102 can transmit an attach request to the MME of the 4G LTE network. The UE 102 and a home subscriber service (HSS) of the 4G LTE network can exchange information for authentication and security. The MME can transmit a session request to a serving gateway (SGW) of the 4G LTE network. The SGW can transmit the session request to a packet data network gateway (PGW), which can transmit an accept or reject response back to the SGW. The SGW can transmit the response back to the MME. The MME can transmit an ATTACH ACCEPT message or an ATTACH REJECT message to the UE 102. Along with the ATTACH ACCEPT message or ATTACH REJECT message, the MME can transmit a list of restricted RATs associated with a current PLMN to the UE 102.

In some embodiments, when the UE 102 moves into a new area, the UE 10 can initiate a TAU procedure. For example, the UE 102 can transmit a TAU REQUEST message to an MME, the MME can transmit a modify bearer request to an SGW, to which the SGW can transmit a modify bearer response back to the MME. The MME can then transmit an update location request to the HSS. The HSS can then transmit a cancel location message to the MME, to which the MME can transmit a cancel location acknowledgment back to the HSS. The MME can transmit, via the second base station 110, a TRACKING AREA UPDATE ACCEPT, or in some cases, a TRACKING AREA UPDATE REJECT message to the UE 102. Along with the TRACKING AREA UPDATE ACCEPT or TRACKING AREA UPDATE REJECT message, the MME can transmit a list of restricted RATs associated with a current PLMN to the UE 102.

As indicated above, the MME can transmit a list of restricted RATS to the UE 102 associated with a current PLMN. The UE 102 can store the list in memory. If the UE 102 has previously received a list of restricted RATS, then the UE 102 can delete the previously stored list and replace with the list received along with the ATTACH ACCEPT, ATTACH REJECT TAU ACCEPT, OR TAU REJECT message. In some instances, the ATTACH ACCEPT message or ATTACH REJECT message does not include a list of restricted RATs. In these instances, the UE 102 can assume that there are no restricted RATs. The UE 102 can further delete any previously stored list of restricted RATs. In the event that the UE 102 has a stored list of restricted RATS, the UE 102 can indicate the list of restricted RATS to the access stratum (AS) for a cell selection and cell re-selection purpose (see, 3GPP Technical Specification (TS) 36.304 V18.2.0 (2024-06), the contents of which is incorporated herein by reference in its entirety for all purposes).

For a 5G network, the UE 102 can capture a primary synchronization signal (PSS) and secondary synchronization signal (SSS) to identify a cell of the 5G network. The UE 102 can then initiate a random access channel (RACH) process and transmit a preamble, to which the second base station 110 can respond with a timing adjustment. The UE 102 can transmit a radio resource control (RRC) set up request message, to which the second base station 110 can respond with configuration information. The UE 102 can then transmit a REGISTRATION REQUEST message, with security credentials and network capability information, to an AMF of the 5G network, to which the AMF can transmit an authentication challenge. The UE 102 can respond with an authentication response. The AMF can transmit a security mode command, and the UE 102 can respond with a security mode complete message. The AMF can transmit a REGISTRATION ACCEPT message, or in some cases a REGISTRATION REJECT message to the UE 102. Along with the REGISTRATION ACCEPT or REGISTRATION REJECT, the AMF can transmit a list of restricted RATs associated with a current PLMN to the UE 102.

In some embodiments, the 5G network can provide the UE 102 with the list of restricted RATs with a CONFIGURATION UPDATE COMMAND message. The network can initiate a configuration update procedure for various reasons, such as change in a network slice, UE mobility change, network policy, or other appropriate reason. For example, the UE 102 can initiate a service request procedure with the AMF via the second base station 110. The AMF can transmit a CONFIGURATION UPDATE COMMAND message to the UE 102 along with the list of restricted RATs. In response, the UE 102 can transmit a CONFIGURATION UPDATE COMPLETE message.

As indicated above, the AMF can include a list of restricted RAT associated with the current registered PLMN in the REGISTRATION ACCEPT message, REGISTRATION REJECT message, SERVICE ACCEPT message, or CONFIGURATION UPDATE COMMAND message. The UE 102 can store the list in memory. If the UE 102 has previously stored a list of restricted RATs, then the UE 102 can delete the list and replace it with replace the stored list on each receipt of the REGISTRATION ACCEPT message. If the REGISTRATION ACCEPT message or REGISTRATION REJECT message does not contain a list, the UE 102 can assume that no RATs are restricted and delete any previously stored list. The UE 102 can indicate the stored list to the AS for cell selection and cell re-selection purpose (see, 3GPP TS TS 38.304 V18.2.0 (2024-06), the contents of which is incorporated herein by reference in its entirety for all purposes). The information on rejected RATs can also be enabled via an enhanced (E) PLMN list in REGISTRATION ACCEPT message.

In other embodiments, a pre-determination of the PLMN-RAT deployment can be made to avoid unnecessary RAT scans in a given area and enable the UE 102 to connect with a network for services faster. In these embodiments, when the UE 102 powers up, it can determine which RATs are restricted for a PLMN based on static configuration files, such as a subscriber identity module (SIM) file or in a non-volatile memory (NVM) configuration directed by the operator the PLMN (e.g., the visited network 108).

A SIM card can include a SIM elementary file (EF) in a file system. In some embodiments, the SIM EF can be configured with PLMN identifiers (IDs) and allowed ACTs (access control technologies), such as allowed RATs. The network (e.g., home network 104 or visited network 108) can reconfigure the SIM EF as needed. For example, if a RAT that was previously restricted is no longer restricted, or vice versa, the network can reconfigure the SIM EF to indicate the change in the restriction of the access technology. This approach can provide flexibility across the UE's power cycle, and network control for areas, where RATs can be dynamically enabled/disabled. For example, if a load on a RAT (5G NR) is overwhelming the network, the network can dynamically reconfigure the UE's SIM EF to indicate that 5G NR is not an allowed RAT for connection or reconnection. Once the load has subsided, the network can reconfigure the SIM EF to indicate that 5G NR is an allowed RAT.

In some embodiments, the SIM card can include an EF-RAT Mode SIM file that the SIM manufacturer or network can configure to indicate only enabled RATs for either a 4G LTE network or a 5G new radio (NR) network. Based on the configuration, the UE 102 can reject using other RATs (e.g., 2G or 3G). This may be useful in situations, in which a RAT may have been phased out and discontinued.

In some embodiments, the UE 102 can strictly adhere to various SIM parameters, such as a user controlled PLMN with access technology (PLMNwACT). This SIM parameter can include a list of PLMN and access technology pairs. This information can be determined by the user and defines preferred PLMNs in priority order. The UE 102 can also strictly adhere to an operator controller PLMN selector with access technology (EF-OPLMNwact). This SIM parameter can be set by the network's operator. For example, this SIM parameter can be based on a roaming agreement with another operator. This SIM parameter can include a list PLMN and access technology pairs. The PLMNs can be listed by order of priority. The UE 102 can be configured to not consider RATs which are not in wACT along with OPLMN.

In some embodiments, the network (e.g., home network 104, visited network 108) can indicate in any of the above described ACCEPT and REJECT messages to redirect to a different RAT in case of a loss of coverage or a restricted RAT. For example, the network can provide this information via an allowed PLMN-RAT combination (PLMNwact). The AS can be informed as to the allowed RAT list to avoid re-selection issues in the future.

In some embodiments, the network (e.g., home network 104, visited network 108) can provide an equivalent (E) PLMN list that is enhanced to include allowed ACTs, where the UE 102 can consider an EPLMN to be equivalent to a registered PLMN. For example, the EPLMN list can indicate that HPLMN 5G has the following EPLMNs: EPLMN1 with allowed RATs 4G, 3G, and 2G; EPLMN2 with allowed RAT 5G; and EPLMN3 with allowed RATs 4G and 2G. If the UE 102 moves into a coverage area from EPLMN3, the AS can reselect to: EPLMN3 4G, TAU ACCEPT (Equivalent PLMN list: HPLMN 5G, EPLMN1,4G,3G,2G).

In some embodiments, the network (e.g., home network 104, visited network 108) can provide an indication of restricted RATs using steering of roaming (SoR) information. (see, transparent container clause 9.11.3.51 in 3GPP TS 24.501 V18.7.0 (2024-06), the contents of which is incorporated herein by reference in its entirety for all purposes). A control plane of a network can provide the UE 102 with SoR information with a list of preferred PLMN and ACT combinations. The UE 102 can then use the SoR information for PLMN selection. For example. The network can use a SoR container IE to indicate information on restricted RATs. For example, the SoR information can include a list of restricted RATs for a specific location, or a specific time durations such as a day or time).

This SoR information can be provided to the UE 102 during a registration procedure. In this sense, the operator can maintain control of the SoR information, and has the flexibility to provide or not provide the SoR information. The SoR information can be for a particular time interval, which provides the network with flexibility for offloading users during peak hours, or provide flexibility if a RAT is being turned on or off at a particular time. The SoR information can be stored in the UE's database. This has the advantage of providing elaborate information, in a secure, dynamic way and information can be updated in a downlink (DL) NAS transport message. In some embodiments, the network (e.g., home network 104, visited network 108) can provide RAT information in a system information block (SIB), as in some cases the UE 102 can lose service if the UE 102 moves out of a current TA. Therefore, the UE 102 can use the information from the SIB to move onto a specific or different roaming partner.

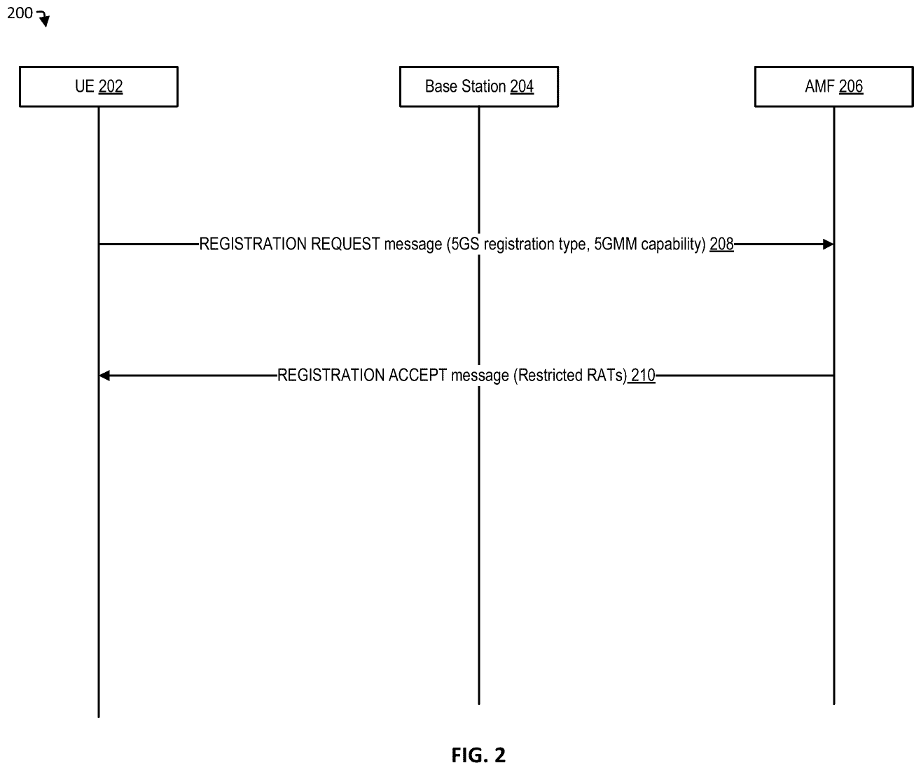

FIGS. 2-6 are signaling diagrams illustrating techniques for providing RAT information to a UE. More detailed descriptions of the processes illustrated in FIGS. 2-6 have been provided above. FIG. 2 is an example signaling diagram 200 for providing RAT information, according to one or more embodiments. As illustrated, a UE 202 can be in communication, via a base station 204, with an AMF 206. At 208, the UE 202 can transmit a REGISTRATION REQUEST message to an AMF 206 of a network (e.g., home network 104 or visited network 108). At 210, the AMF 206 can process the request and transmit a REGISTRATION ACCEPT message to the UE 202, that includes a list of restricted RATs. As indicated above, in some instances, the AMF 206 can transmit a REGISTRATION REJECT message that includes a list of restricted RATs.

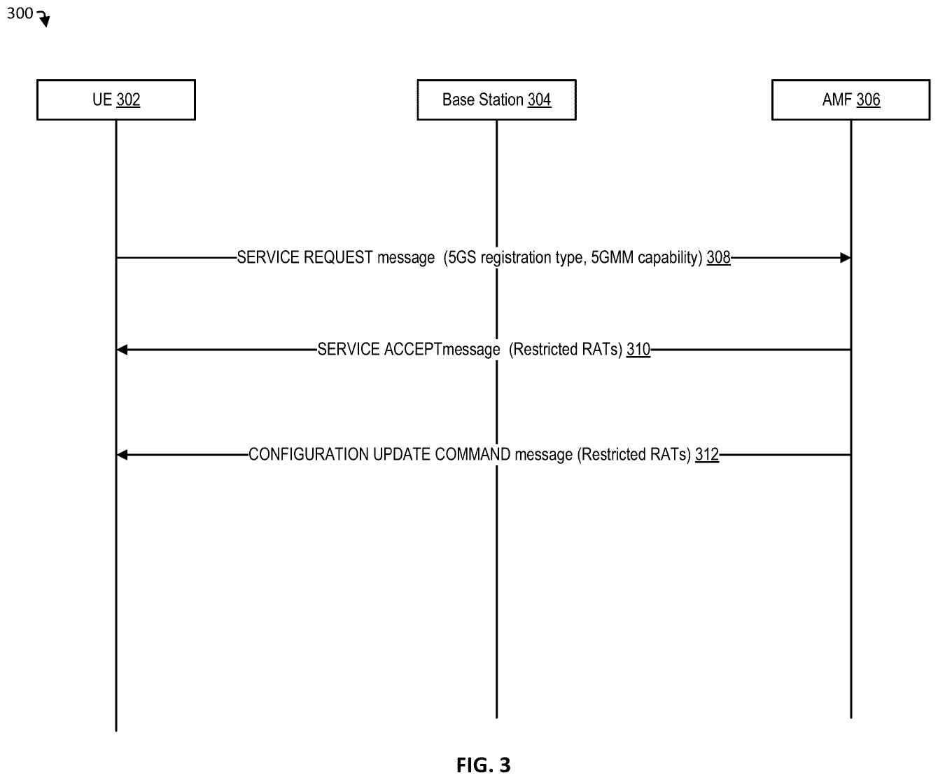

FIG. 3 is an example signaling diagram 300 for providing RAT information, according to one or more embodiments. As illustrated, a UE 302 can be in communication, via a base station 304, with an AMF 306. At 208, the UE 302 can transmit a SERVICE REQUEST message to an AMF 306 of a network (e.g., home network 104 or visited network 108). At 310, the AMF 206 can process the request and transmit a SERVICE ACCEPT message to the UE 302, that includes a list of restricted RATs. As indicated above, in some instances, the AMF 306 can transmit a SERVICE REJECT message that includes a list of restricted RATs. In some instances, at 312, the AMF 306 can transmit a CONFIGURATION UPDATE COMMAND message that includes the RAT information to the UE 302.

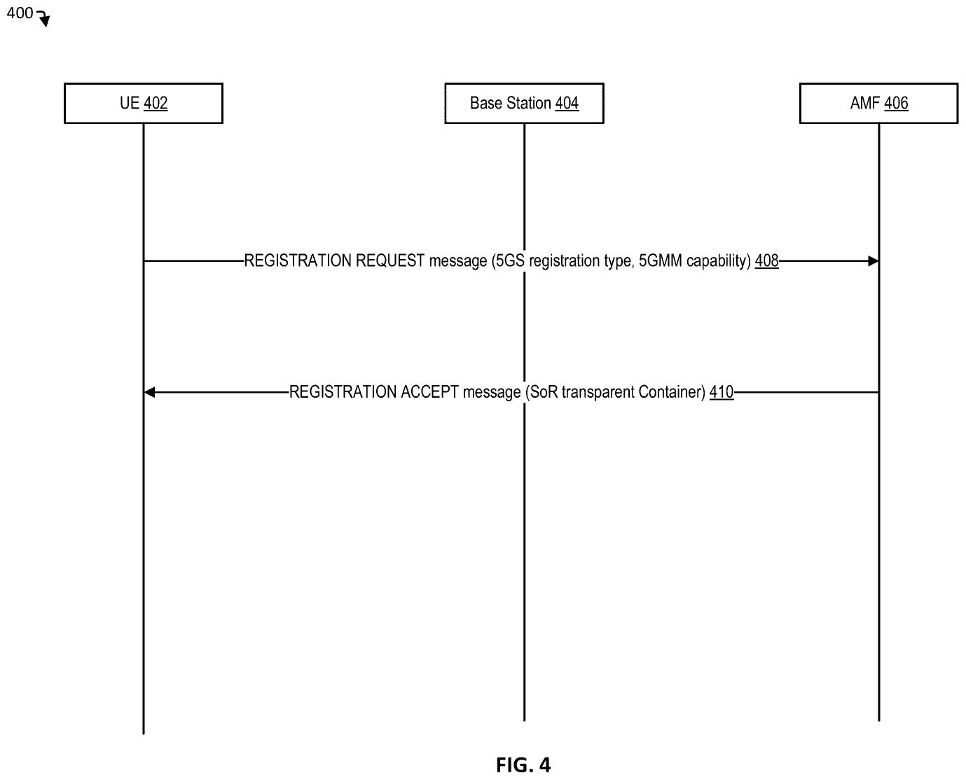

FIG. 4 is an example signaling diagram 400 for providing RAT information, according to one or more embodiments. As illustrated, a UE 402 can be in communication, via a base station 404, with an AMF 406. At 208, the UE 402 can transmit a REGISTRATION REQUEST message to an AMF 406 of a network (e.g., home network 104 or visited network 108). At 410, the AMF 206 can process the request and transmit a REGISTRATION ACCEPT message to the UE 402, that includes the above described SoR information. As indicated above, in some instances, the AMF 206 can transmit a REGISTRATION REJECT message that includes the SoR information.

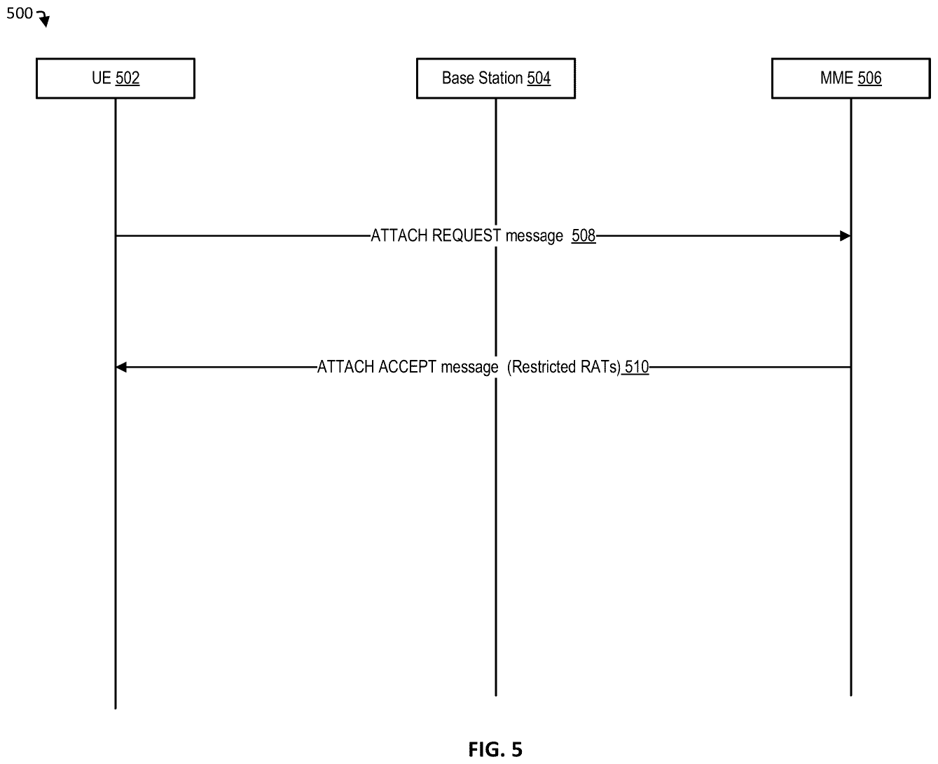

FIG. 5 is an example signaling diagram 500 for providing RAT information, according to one or more embodiments. As illustrated, a UE 502 can be in communication, via a base station 504, with an MME 506. At 508, the UE 502 can transmit an ATTACH REQUEST message to an MME 506 of a network (e.g., home network 104 or visited network 108). At 510, the MME 506 can process the request and transmit an ATTACH ACCEPT message to the UE 502, that includes a list of restricted RATs. As indicated above, in some instances, the MME 506 can transmit an ATTACH REJECT message that includes a list of restricted RATs.

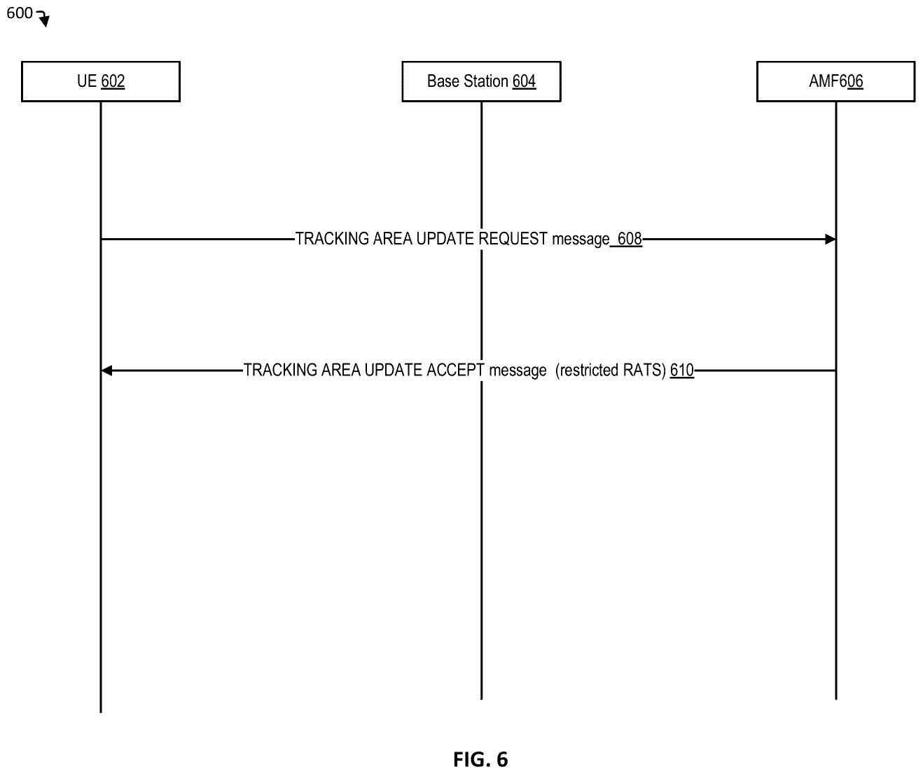

FIG. 6 is an example signaling diagram 600 for providing RAT information, according to one or more embodiments. As illustrated, a UE 602 can be in communication, via a base station 604, with an MME 606. At 608, the UE 602 can transmit a TRACKING AREA UPDATE (TAU) REQUEST message to an MME 606 of a network (e.g., home network 104 or visited network 108). At 610, the MME 606 can process the request and transmit a TRACKING AREA UPDATE ACCEPT message to the UE 602, that includes a list of restricted RATs. As indicated above, in some instances, the MME 506 can transmit a TRACKING AREA UPDATE REJECT message that includes a list of restricted RATs.

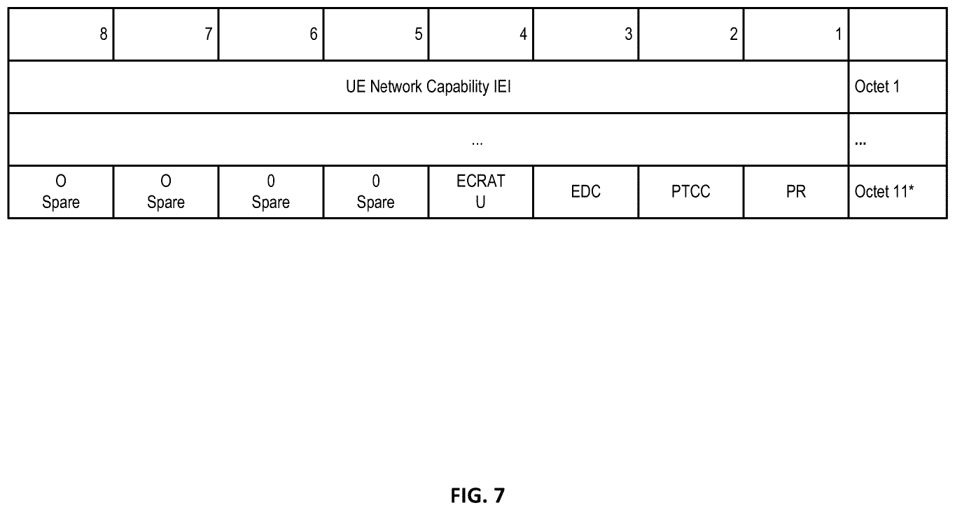

FIGS. 7-17 are illustrations of IEs and tables used to convey RAT information. It should be appreciated that the IEs and tables are illustrated in an abbreviated format and in a real world scenario, each can include additional information.

FIG. 7 is an illustration of an example UE network capability information element (IE) according to one or more embodiments. As illustrated, the enhancement of the controller RAT utilization (ECRATU) is provided in octet 11, bit 4. This bit can indicate the capability to support ECRATU for EPS. For example, a zero bit value can indicate that ECRATU is not supported in EPS. Or a one bit value can indicate that ECRATU is supported in EPS.

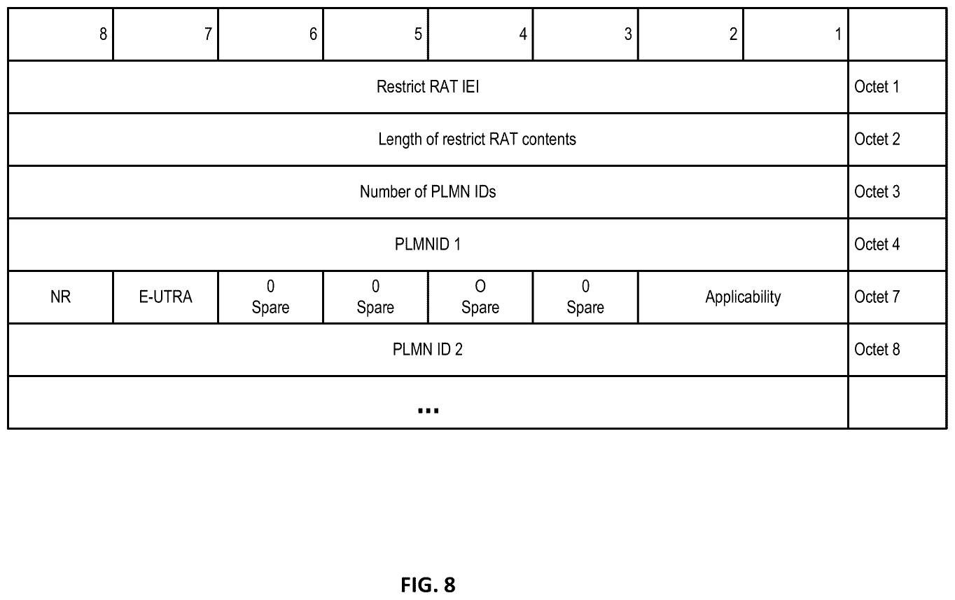

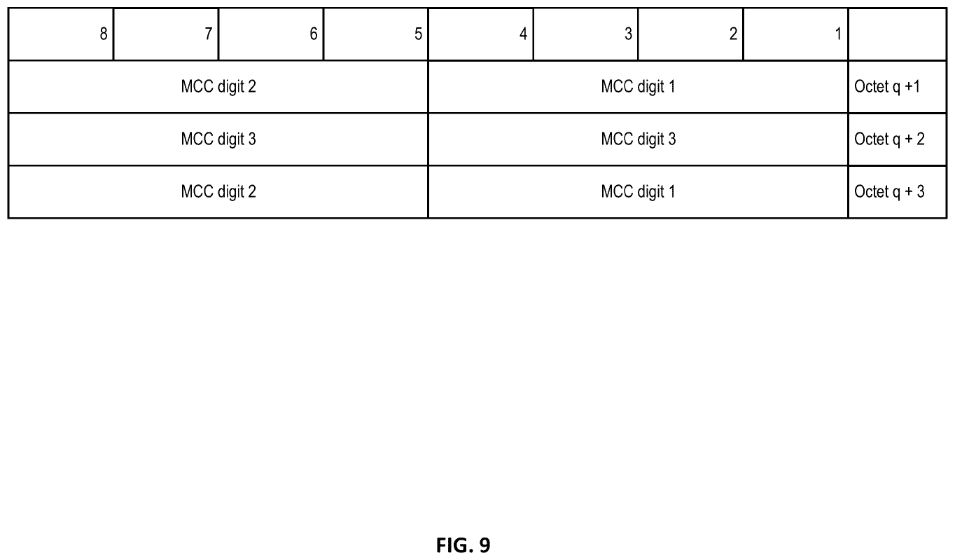

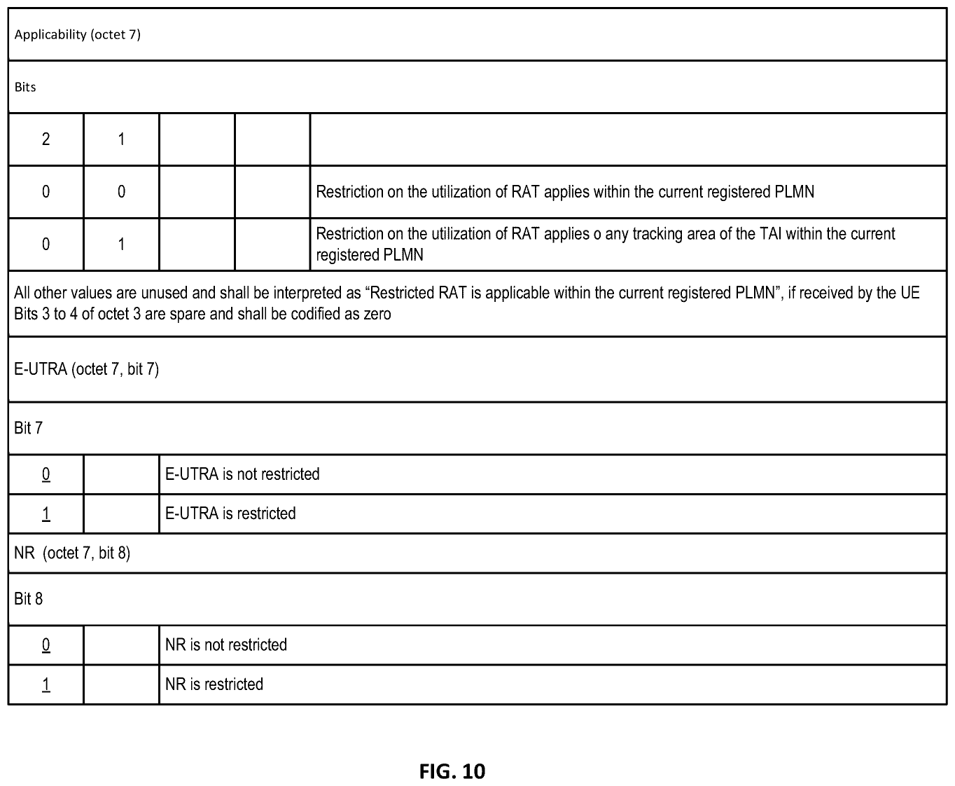

FIG. 8 is an illustration of an example restricted RAT IE, according to one or more embodiments. FIG. 9 is an illustration of an example PLMN identifier, according to one or more embodiments. FIG. 10 is an illustration of an example restricted RAT IE, according to one or more embodiments. The purpose of the restricted RAT information element is for the network to communicate a list of “restricted RATs” to the UE. The restricted RAT IE is coded as shown in FIGS. 8, 9 and 10. The restricted RAT is a type 4 information element. It should be appreciated that EPS (4G) and 5G RATs are described herein, other 2G/3G RATs such as global system for mobile communication (GSM) and universal mobile telecommunication service (UMTS) can also be restricted based on the techniques described herein.

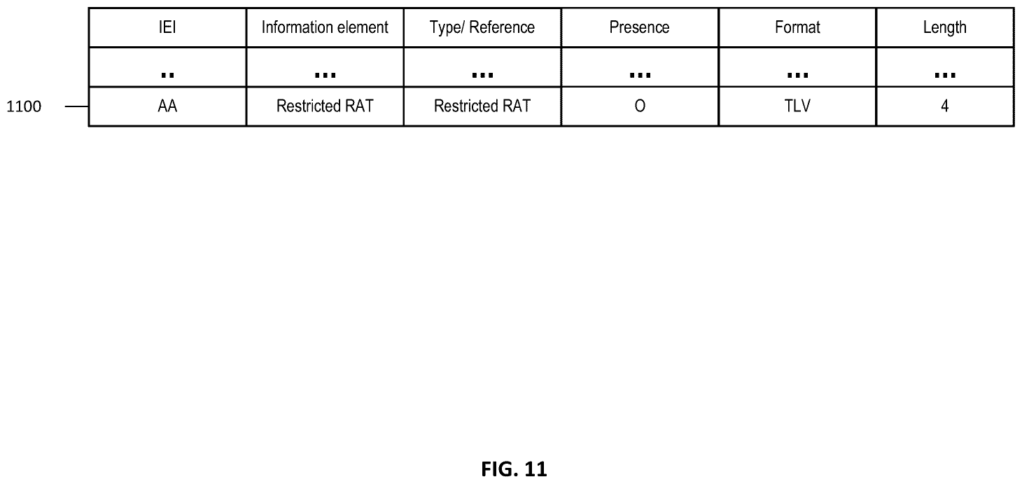

FIG. 11 is an illustration of an ATTACH ACCEPT message, according to one or more embodiments. The ATTACH ACCEPT message 1100 can include an IE to indicate that the restricted RAT is associated with a current registered PLMN.

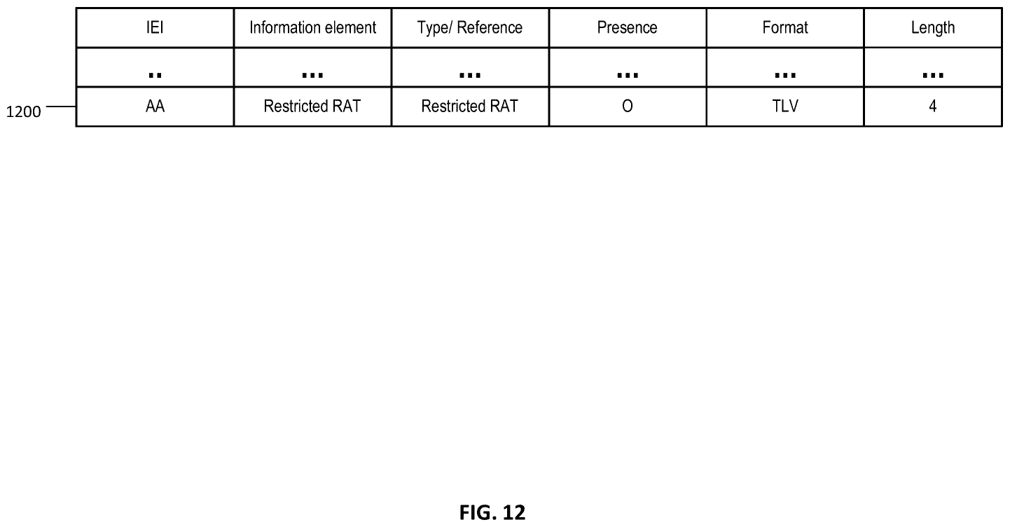

FIG. 12 is an illustration of a TRACKING AREA UPDATE ACCEPT message, according to one or more embodiments. The TRACKING AREA UPDATE ACCEPT message 1200 can include an IE to indicate that the restricted RAT is associated with the current PLMN.

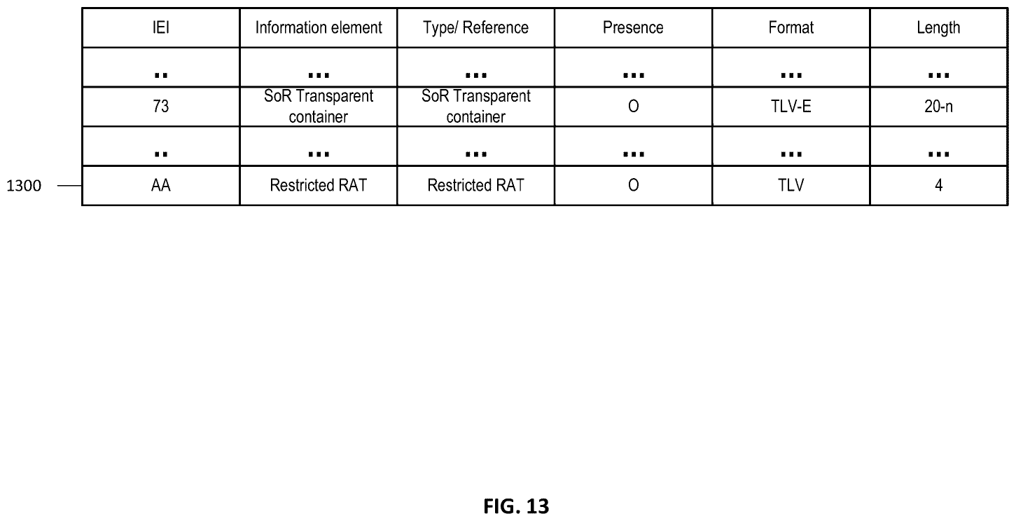

FIG. 13 is an illustration of a REGISTRATION ACCEPT message, according to one or more embodiments. This REGISTRATION ACCEPT message 1300 can include an IE to indicate the restricted RAT is associated with the current PLMN. The REGISTRATION ACCEPT message 1300 can also include another IE to indicate the restricted RAT is indicated in SoR information.

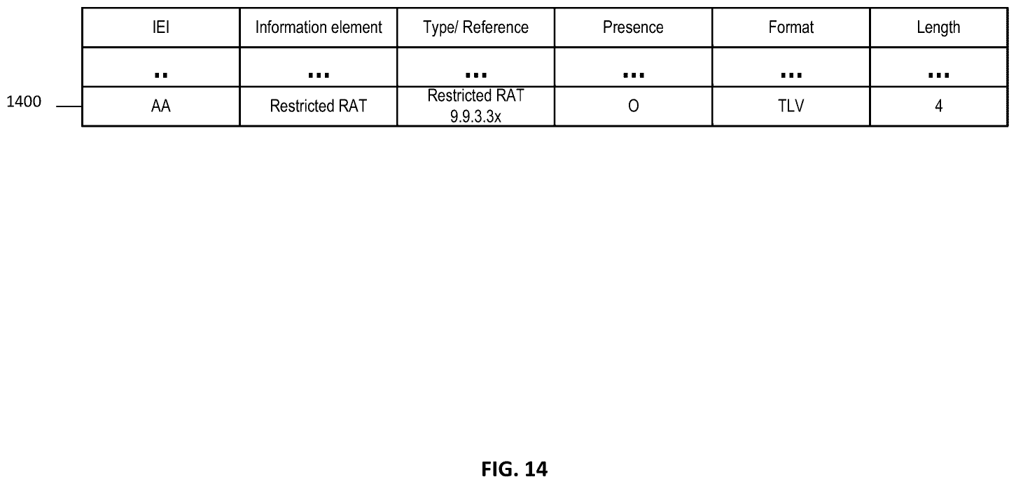

FIG. 14 is an illustration of a REGISTRATION REJECT message, according to one or more embodiments. This REGISTRATION REJECT message 1400 can include an IE to indicate that the restricted RAT is associated with the current PLMN.

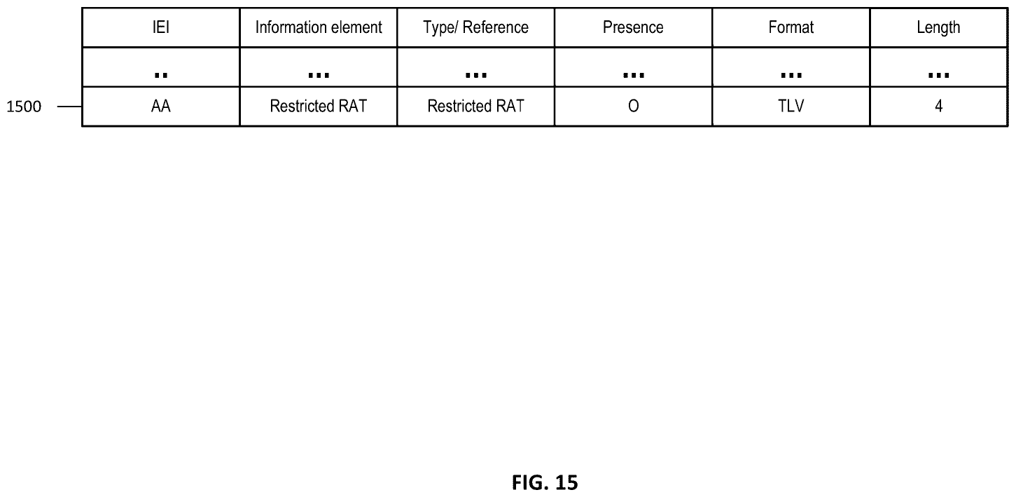

FIG. 15 is an illustration of a CONFIGURATION UPDATE COMMAND message, according to one or more embodiments. This CONFIGURATION UPDATE COMMAND message 1500 can include an IE to indicate that the restricted RAT is associated with the current PLMN.

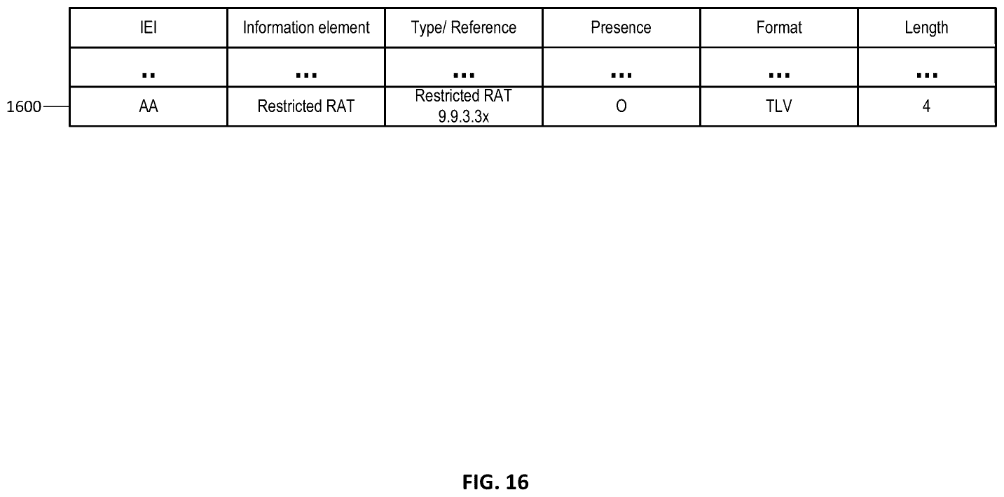

FIG. 16 is an illustration of a SERVICE ACCEPT message, according to one or more embodiments. This IE 1600 can be included to indicate the restricted RAT is associated with the current PLMN.

In some embodiments, a universal subscriber identity module (USIM) can be configured to store a restricted RAT access technology identifier for each PLMN. The USIM can also be configured to store the location (location area identity, tracking area) where a corresponding RAT may be applicable. For example, the USIM can store information that indicates that at a particular tracking area 5G is restricted from use for some or all UEs. Furthermore, 3GPP TS 31.102 V18.5.0 (2024-06) can be updated. In particular, the updates can indicate:
Service no 151; Operator controller Restricted RAT
4.2.145 EF_{OCRESTRAT} (Operator controlled restricted RATs per PLMN
If service no 151 is “available”, this field shall be present.

This EF contains the coding for n LAC/TAC, Access Technologies and the associated operator controlled restricted RATs for the PLMN 9see TS 24.501).

A value of ‘FF0000’ stored bytes 4 to 6 and a value of ‘FFFFFE’ shall be used to indicate the entire range of TACs/LACs for a given PLMN when TAC is 2 bytes.

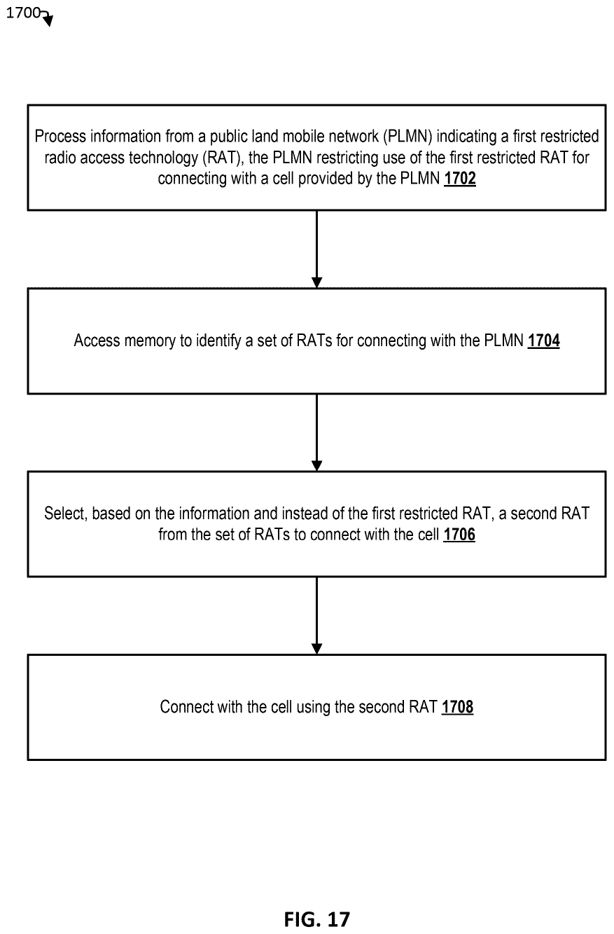

FIG. 17 is an example process 1700 for providing RAT information, according to one or more embodiments. At 1702, the process 1700 can include an apparatus of a UE (e.g., UE 102) processing information from a PLMN (e.g., home network 104 or visited network 108) indicating a first restricted RAT (e.g., 5G). The PLMN can restrict use of the first restricted RAT for connecting with a cell provided by the PLMN.

At 1704, the process 1700 can include the apparatus accessing memory to identify a set of RATs for connecting with the PLMN. The UE can include a set of available RATs that it can select from to connect with the PLMN.

At 1706 the process 1700 can include the apparatus selecting, based on the information and instead of the first restricted RAT, a second RAT from the set of RATs to connect with the cell. For example, the set of RATs can include 4G LTE and 5G NR. Based on 5G NR being a restricted RAT, the apparatus can select 4G LTE.

At 1708, the process 1700 can include the apparatus connecting with the cell using the second RAT. In the instance that the apparatus determines that the first RAT is no longer restricted, the apparatus can attempt to connect to the cell using the first RAT.

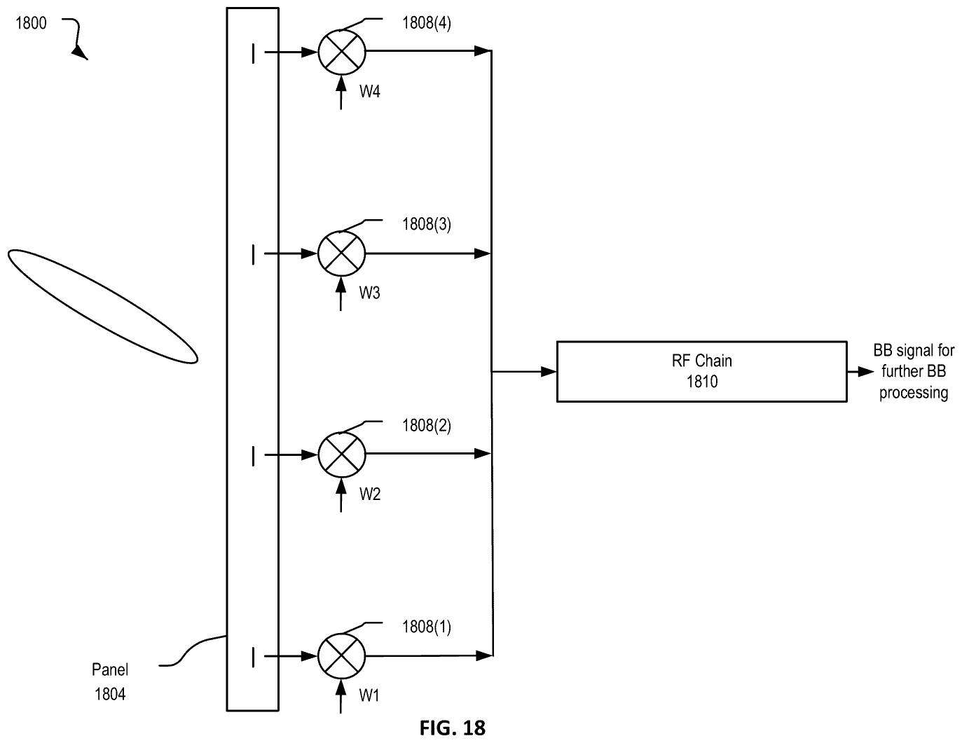

FIG. 18 illustrates receive components 1800 of a UE (e.g., UE 102), in accordance with some embodiments. The receive components 1800 may include an antenna panel 1804 that includes a number of antenna elements (e.g., for communicating with a terrestrial or non-terrestrial base station). The panel 1804 is shown with four antenna elements, but other embodiments may include other numbers. For example, the antenna elements can be used to receive signaling that includes the RAT information.

The antenna panel 1804 may be coupled to analog beamforming (BF) components that include a number of phase shifters 1808(1)-1808(4). The phase shifters 1808(1)-1808(4) may be coupled with a radio-frequency (RF) chain 1813. The RF chain 1813 may amplify a receive analog RF signal, downconvert the RF signal to baseband, and convert the analog baseband signal to a digital baseband signal that may be provided to a baseband processor for further processing.

In various embodiments, control circuitry, which may reside in a baseband processor, may provide BF weights (e.g., W1-W4), which may represent phase shift values, to the phase shifters 1808(1)-1808(4) to provide a receive beam at the antenna panel 1804. These BF weights may be determined based on the channel-based beamforming.

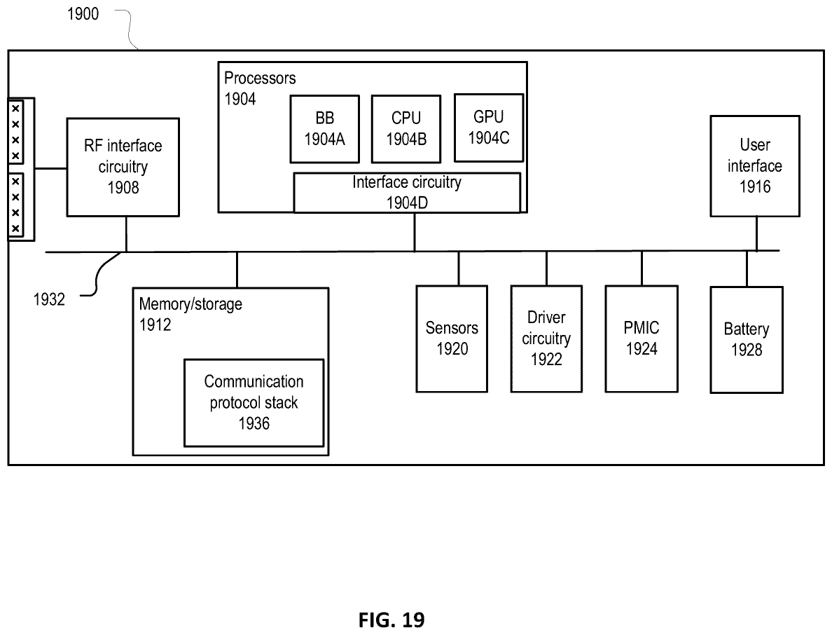

FIG. 19 illustrates a UE 1900, in accordance with some embodiments. The UE 1900 may be similar to and substantially interchangeable with the UE described with respect to FIG. 18.

Similar to that described above with respect to UE 1900, the UE 1900 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 1900 may include processors 1904, RF interface circuitry 1908, memory/storage 1913, user interface 1916, sensors 1920, driver circuitry 1922, power management integrated circuit (PMIC) 1924, and battery 1928. The components of the UE 1900 may be implemented as integrated circuits (ICs), portions thereof, discrete electronic devices, or other modules, logic, hardware, software, firmware, or a combination thereof. The block diagram of FIG. 19 is intended to show a high-level view of some of the components of the UE 1900. However, some of the components shown may be omitted, additional components may be present, and different arrangements of the components shown may occur in other implementations.

The components of the UE 1900 may be coupled with various other components over one or more interconnects 1932, which may represent any type of interface, input/output, bus (local, system, or expansion), transmission line, trace, optical connection, etc. that allows various circuit components (on common or different chips or chipsets) to interact with one another.

The processors 1904 may include processor circuitry such as, for example, baseband processor circuitry (BB) 1904A, central processor unit circuitry (CPU) 1904B, and graphics processor unit circuitry (GPU) 1904C. The processors 1904 may include any type of circuitry or processor circuitry that executes or otherwise operates computer-executable instructions, such as program code, software modules, or functional processes from memory/storage 1913 to cause the UE 1900 to perform operations as described herein, such as determining a RAT to use to connect to a network based a list of restricted RATs.

In some embodiments, the baseband processor circuitry 1904A may access a communication protocol stack 1936 in the memory/storage 1913 to communicate over a 3GPP compatible network. In general, the baseband processor circuitry 1904A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 1908.

The baseband processor circuitry 1904A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1913 may include any type of volatile or non-volatile memory that may be distributed throughout the UE 1900. In some embodiments, some of the memory/storage 1913 may be located on the processors 1904 themselves (for example, L1 and L2 cache), while other memory/storage 1913 is external to the processors 1904 but accessible thereto via a memory interface. The memory/storage 1913 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1908 may include transceiver circuitry and a radio frequency front module (RFEM) that allows the UE 1900 to communicate with other devices over a radio access network. The RF interface circuitry 1908 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via an antenna 1924 and proceed to filter and amplify (with a low-noise amplifier) the signal. The signal may be provided to a receiver of the transceiver that down-converts the RF signal into a baseband signal that is provided to the baseband processor of the processors 1904.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1924.

In various embodiments, the RF interface circuitry 1908 may be configured to transmit/receive signals in a manner compatible with NR access technologies.

The antenna 1924 may include a number of antenna elements that each convert electrical signals into radio waves to travel through the air and to convert received radio waves into electrical signals. The antenna elements may be arranged into one or more antenna panels. The antenna 1924 may have antenna panels that are omnidirectional, directional, or a combination thereof to enable beamforming and multiple input, multiple output communications. The antenna 1924 may include microstrip antennas, printed antennas fabricated on the surface of one or more printed circuit boards, patch antennas, phased array antennas, etc. The antenna 1924 may have one or more panels designed for specific frequency bands including bands in FR1 or FR2.

The user interface circuitry 1916 includes various input/output (I/O) devices designed to enable user interaction with the UE 1900. The user interface 1916 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, projectors, etc.), with the output of characters, graphics, multimedia objects, and the like being generated or produced from the operation of the UE 1900.

The sensors 1920 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1922 may include software and hardware elements that operate to control particular devices that are embedded in the UE 1900, attached to the UE 1900, or otherwise communicatively coupled with the UE 1900. The driver circuitry 1922 may include individual drivers allowing other components to interact with or control various input/output (I/O) devices that may be present within, or connected to, the UE 1900. For example, driver circuitry 1922 may include a display driver to control and allow access to a display device, a touchscreen driver to control and allow access to a touchscreen interface, sensor drivers to obtain sensor readings of sensor circuitry 1920 and control and allow access to sensor circuitry 1920, drivers to obtain actuator positions of electro-mechanic components or control and allow access to the electro-mechanic components, a camera driver to control and allow access to an embedded image capture device, audio drivers to control and allow access to one or more audio devices.

The PMIC 1924 may manage power provided to various components of the UE 1900. In particular, with respect to the processors 1904, the PMIC 1924 may control power-source selection, voltage scaling, battery charging, or DC-to-DC conversion.

In some embodiments, the PMIC 1924 may control, or otherwise be part of, various power saving mechanisms of the UE 1900. For example, if the platform UE is in an RRC_Connected state, where it is still connected to the radio access network (RAN) node as it expects to receive traffic shortly, then it may enter a state known as Discontinuous Reception Mode (DRX) after a period of inactivity. During this state, the UE 1900 may power down for brief intervals of times and thus save power. If there is no data traffic activity for an extended period of time, then the UE 1900 may transition off to an RRC_Idle state, where it disconnects from the network and does not perform operations such as channel quality feedback, handover, etc. The UE 1900 goes into a very low power state and it performs paging where again it periodically wakes up to listen to the network and then powers down again. The UE 1900 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 1928 may power the UE 1900, although in some examples the UE 1900 may be mounted deployed in a fixed location, and may have a power supply coupled to an electrical grid. The battery 1928 may be a lithium ion battery, a metal-air battery, such as a zinc-air battery, an aluminum-air battery, a lithium-air battery, and the like. In some implementations, such as in vehicle-based applications, the battery 1928 may be a typical lead-acid automotive battery.

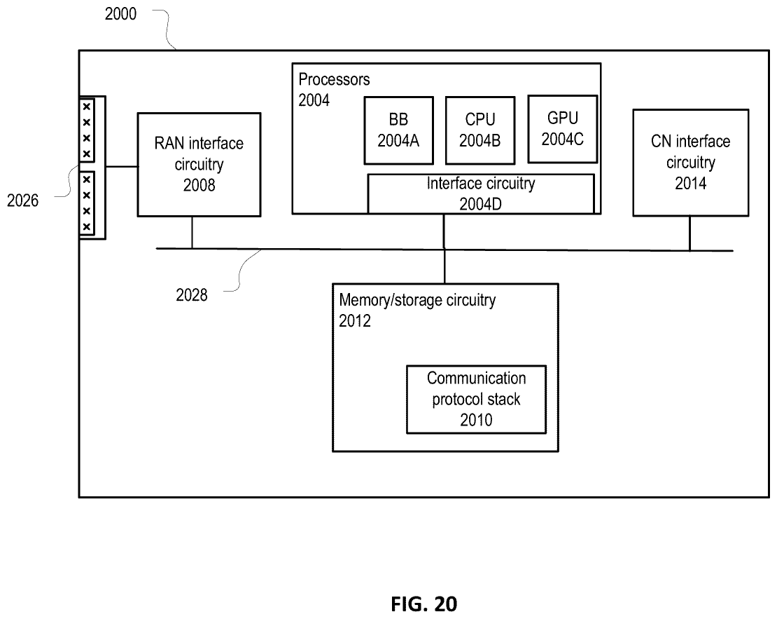

FIG. 20 illustrates a network node 2000 (e.g., a terrestrial base station or a non-terrestrial base station), in accordance with some embodiments. The network node 2000 may include processors 2004, RF interface circuitry 2008, core network (CN) interface circuitry 2013, and memory/storage circuitry 2016. The network node 2000 can be a node of a RAN or a CN. The network node 2000 can be configured to transmit RAT information to a UE (e.g., UE 102)

The components of the network node 2000 may be coupled with various other components over one or more interconnects 2028.

The processors 2004, RF interface circuitry 2008, memory/storage circuitry 2016 (including communication protocol stack 2010), antenna 2024, and interconnects 2028 may be similar to like-named elements shown and described with respect to FIG. 19.

The CN interface circuitry 2013 may provide connectivity to a CN, for example, a 4th Generation Core network (5GC) using a 4GC-compatible network interface protocol such as carrier Ethernet protocols, or some other suitable protocol. Network connectivity may be provided to/from the network node 2000 via a fiber optic or wireless backhaul. The CN interface circuitry 2013 may include one or more dedicated processors or FPGAs to communicate using one or more of the aforementioned protocols. In some implementations, the CN interface circuitry 2013 may include multiple controllers to provide connectivity to other networks using the same or different protocols.

As indicated above, in other embodiments, the network node 2000 can be a CN node. In these embodiments, the network node 2000 include RF interface circuitry 2008 for connectivity with a RAN. The RF interface circuitry 2008 may include one or more dedicated processors or FPGAs to communicate using one or more of the aforementioned protocols. In some implementations, the RF interface circuitry 2008 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### Examples

In the following sections, further example embodiments are provided.

Example 1 can include a method comprising: processing information from a PLMN indicating a first restricted RAT, the PLMN restricting use of the first restricted RAT for connecting with a cell provided by the PLMN; accessing memory to identify a set of RATs for connecting with the PLMN; selecting, based on the information and instead of the first restricted RAT, a second RAT from the set of RATs to connect with the cell; and connecting with the cell using the second RAT.

Example 2 can include the method of example 1, wherein the information further indicates that the first restricted RAT is associated with a tracking area (TA), the PLMN further restricting use of the first restricted RAT for connecting with the cell within the TA.

Example 3 can include the method of example 1, wherein the information further indicates that first restricted RAT is associated with a country, the PLMN further restricting the use of the first restricted RAT connecting with the cell within the country.

Example 4 can include the method of any of examples 1-3, wherein the information comprises an information element (IE) indicating the first restricted RAT, wherein a validity of the IE is based on a timer value, and wherein the method further comprises: activating a timer associated with the IE; determining the validity of the IE based on whether the timer has reached the expiration value; and selecting the second RAT based on whether the timer has reached the expiration value.

Example 5 can include the method of any of examples 1-4, wherein the method further comprises: transmitting a REGISTRATION REQUEST message to an access and mobility management function (AMF) of the PLMN; and processing a response message from the AMF, wherein the response message indicates the first restricted RAT, and wherein the response message is a REGISTRATION ACCEPT message or a REGISTRATION REJECT message.

Example 6 can include the method of any of examples 1-3, wherein the method further comprises: transmitting a SERVICE REQUEST message to an AMF of the PLMN; and processing a response message from the AMF, wherein the response message indicates the first restricted RAT, and wherein the response message is a SERVICE ACCEPT message, a SERVICE REJECT message, or a CONFIGURATION UPDATE COMMAND message.

Example 7 can include the method of any of examples 1-3, wherein the method further comprises: transmitting a REGISTRATION REQUEST message to an AMF of the PLMN; and processing a response message from the AMF, wherein the response message indicates the first restricted RAT, and wherein the response message comprises steering of roaming (SoR) information.

Example 8 can include the method of example 7, wherein the SoR information comprises a specific location within which the PLMN restricts the first restricted RAT or a time interval during which the PLMN restricts the first restricted RAT.

Example 9 can include the method of any of example 1, wherein the information is provided by the PLMN via a system information block (SIB).

Example 10 can include the method of any of examples 1-3, wherein the method further comprises: transmitting an ATTACH REQUEST message to a mobility management entity (MME) of the PLMN; and processing a response message from the MME, wherein the response message indicates the first restricted RAT and comprises an ATTACH ACCEPT message or an ATTACH REJECT message.

Example 11 can include the method of any of examples 1-3, wherein the method further comprises: transmitting a TRACKING AREA UPDATE (TAU) message to a mobility management entity (MME) of the PLMN; and processing a response message from the MME, wherein the response message indicates the first restricted RAT and comprises a TAU ACCEPT message or a TAU REJECT message.

Example 12 can include the method of any of examples 1-11, wherein the information comprises a first list of restricted RATs including the first restricted RAT, and wherein the method further comprises: accessing the memory to identify a second list of restricted RATs stored in the memory based on processing the information; deleting the second list of restricted RATs; and storing the first list of restricted RATs in the memory.

Example 13 can include the method of example 12, wherein the method further comprises: transmitting a message to an access stratum (AS) of the PLMN to indicate the first list restricted RATs.

Example 14 can include an apparatus comprising: processing circuitry configured to perform any of the steps of examples 1-13; and memory coupled to the processing circuitry, the memory configured to store RAT information.

Example 15 can include one or more non-transitory computer-readable media having stored thereon a sequence of instructions which, when executed by one or more processors, cause processing circuitry to perform any of the steps of examples 1-13.

Example 16 can include an apparatus comprising: processing circuitry configured to: access a subscriber identity module (SIM) file indicating a first allowed radio access technology (RAT) for a public land mobile network (PLMN), identify a cell of the PLMN, select, based on the SIM file, the first allowed RAT from a set of RATs to connect with the cell, and connect with the cell of the PLMN using the first allowed RAT; and memory coupled to the processing circuitry, the memory configured to store the SIM file.

Example 17 can include the apparatus of example 16, wherein the SIM file is configured for the first allowed RAT, and wherein apparatus is configured to reject a second restricted RAT based on the SIM file.

Example 18 can include the apparatus of any of examples 16 or 17, wherein the SIM file is configured to indicate the first allowed RAT based on a user controlled PLMN with access technology (PLMNwACT) or an operator controller PLMN selector with access technology (EF-OPLMNwact).

Example 19 can include a method for performing any of the steps of examples 16-18.

Example 20 can include one or more non-transitory computer-readable media having stored thereon a sequence of instructions which, when executed by one or more processors, cause processing circuitry to perform any of the steps of examples 16-18.

Example 21 can include one or more non-transitory computer-readable media having stored thereon a sequence of instructions which, when executed by one or more processors, cause processing circuitry to: transmit a message to an access and mobility management (AMF) function of a public land mobile network (PLMN); process a response from the AMF indicating that a first radio access technology (RAT) is restricted; access memory to identify a set of RATs for connecting with the PLMN; select, based on the first RAT being restricted, a second RAT from the set of RATs to connect with a cell provided by the PLMN; and connect with the cell using the second RAT.

Example 22 can include the one or more non-transitory computer-readable media of example 21, wherein execution of the sequence of instructions further cause the processing circuitry to: disable the first RAT from the set of RATs based on the response.

Example 23 can include the one or more non-transitory computer-readable media of any of examples 21 or 22, wherein the message is a REGISTRATION REQUEST message or a SERVICE REQUEST message.

Example 24 can include the one or more non-transitory computer-readable media of any of examples 21 or 22, wherein the response further indicates that the first RAT is associated with a tracking area (TA), the PLMN further restricting use of the first RAT for connecting with the cell within the TA.

Example 25 can include a method for performing any of the steps of examples 21-24.

Example 26 can include an apparatus comprising: processing circuitry configured to perform any of the steps of examples 21-24; and memory coupled to the processing circuitry, the memory configured to store RAT information.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
processing information from a public land mobile network (PLMN) indicating a first restricted radio access technology (RAT);
accessing memory to identify a set of RATs for connecting with the PLMN;
selecting a second RAT instead of the first restricted RAT from the set of RATs based on the indication of the first restricted RAT; and
connecting with a cell of the PLMN using the second RAT.

2. The method of claim 1, wherein the information further indicates that the first restricted RAT is associated with a tracking area (TA), and wherein the PLMN further restricts use of the first restricted RAT for connecting with the cell within the TA.

3. The method of claim 1, wherein the information further indicates that the first restricted RAT is associated with a country, and wherein the PLMN further restricts use of the first restricted RAT connecting with the cell within the country.

4. The method of claim 1, wherein the information comprises an information element (IE) indicating the first restricted RAT.

5. The method of claim 1, wherein the method further comprises:
transmitting a REGISTRATION REQUEST message to an access and mobility management function (AMF) of the PLMN; and
processing a response message from the AMF, wherein the response message comprises the information, and wherein the response message comprises a REGISTRATION ACCEPT message or a REGISTRATION REJECT message.

6. The method of claim 1, wherein the method further comprises:
transmitting a SERVICE REQUEST message to an access and mobility management function (AMF) of the PLMN; and
processing a response message from the AMF, wherein the response message comprises the information, and wherein the response message comprises a SERVICE ACCEPT message, a SERVICE REJECT message, or a CONFIGURATION UPDATE COMMAND message.

7. The method of claim 1, wherein the method further comprises:
transmitting a REGISTRATION REQUEST message to an access and mobility management function (AMF) of the PLMN, wherein the REGISTRATION REQUEST message comprises a bit indicating support for radio access control (RAT) control; and
processing a response message from the AMF, wherein the response message comprises the information.

8. The method of claim 7, wherein the response message comprises steering of roaming (SoR) information, and wherein the SoR information comprises a specific location within which the PLMN restricts the first restricted RAT or a time interval during which the PLMN restricts the first restricted RAT.

9. The method of claim 1, wherein the information comprises a type 4 information element (IE).

10. The method of claim 1, wherein the method further comprises:
transmitting an ATTACH REQUEST message to a mobility management entity (MME) of the PLMN; and
processing a response message from the MME, wherein the response message comprises the information, and wherein the response message comprises an ATTACH ACCEPT message or an ATTACH REJECT message.

11. The method of claim 1, wherein the method further comprises:
transmitting a TRACKING AREA UPDATE (TAU) message to a mobility management entity (MME) of the PLMN; and
processing a response message from the MME, wherein the response message comprises the information, and wherein the response message comprises a TAU ACCEPT message or a TAU REJECT message.

12. The method of claim 1, wherein the method further comprises:
receiving a first list of restricted RATS;
accessing the memory to identify a second list of restricted RATs stored in the memory wherein the second list comprises the first restricted RAT;
deleting the second list of restricted RATs; and
storing the first list of restricted RATs in the memory.

13. The method of claim 1, wherein the method further comprises:
receiving an ATTACH response;
determining that the ATTACH response does not include a list of restricted RATs; and
determining that no RATs are restricted RATs based on the ATTACH response does not include a list of restricted RATs.

14. An apparatus comprising:
processing circuitry configured to:
access a subscriber identity module (SIM) file indicating a first allowed radio access technology (RAT) for a public land mobile network (PLMN),
identify a cell of the PLMN,
select, based on the SIM file, the first allowed RAT from a set of RATs to connect with the cell, and
connect with the cell of the PLMN using the first allowed RAT; and
memory coupled to the processing circuitry, the memory configured to store the SIM file.

15. The apparatus of claim 14, wherein the SIM file is configured for the first allowed RAT, and wherein apparatus is configured to reject a second restricted RAT based on the SIM file.

16. The apparatus of claim 14, wherein the SIM file is configured to indicate the first allowed RAT based on a user controlled PLMN with access technology (PLMNwACT) or an operator controller PLMN selector with access technology (EF-OPLMNwact).

17. One or more non-transitory computer-readable media having stored thereon instructions that, when executed, cause processing circuitry to:
generate a message comprising a bit indicating support for radio access control (RAT) control;
transmit the message to an access and mobility management (AMF) function of a public land mobile network (PLMN);
process a response from the AMF indicating that a first RAT is restricted;
access memory to identify a set of RATs for connecting with the PLMN;
select, based on the first RAT being restricted, a second RAT from the set of RATs to connect with a cell provided by the PLMN; and
connect with the cell using the second RAT.

18. The one or more non-transitory computer-readable media of claim 17, wherein the instructions, when executed, further cause the processing circuitry to:
disable the first RAT from the set of RATs based on the response.

19. The one or more non-transitory computer-readable media of claim 17, wherein the message is a REGISTRATION REQUEST message or a SERVICE REQUEST message.

20. The one or more non-transitory computer-readable media of claim 17, wherein the message is a TRACKING AREA UPDATE REQUEST message, and wherein the response is a TRACKING AREA UPDATE ACCEPT response and further indicates that the first RAT is associated with a tracking area (TA).
